(19) United States
(12) Patent Application Publication
(10) Pub. No.: US 2009/0029808 A1
(43) Pub. Date: Jan. 29, 2009

(54) SPORTING DEVICE WITH INTERACTIVE DISPLAY

(76) Inventor: Antonio Fore, Milwaukee, WI (US)

Correspondence Address: BOYLE FREDRICKSON S.C., 840 North Plankinton Avenue, MILWAUKEE, WI, 53203, US

(21) Appl. No.: 12/178,114

(22) Filed: Jul. 23, 2008

Related U.S. Application Data
(60) Provisional application No. 60/951,549, filed on Jul. 24, 2007.

(51) Int. Cl. A63B 63/08; G02F 1/133

(52) U.S. Cl. 473/481; 349/33; 349/58; 252/299.01

(57) ABSTRACT

A sporting device having a display integrated into the construction of the sporting device and preferably configured to be responsive to the sporting activity. Preferably, the display is formed by a liquid crystal sheet that is visible through the structure of the sporting device. The liquid crystal sheet can be remotely operated or otherwise configured to provide a pre-selected display. Alternatively, operation of the liquid crystal sheet is controlled by the activity associated with the sporting device.

### CROSS REFERENCE TO RELATED APPLICATIONS

This application claims priority to U.S. Patent Application Ser. No. 60/951,549 filed on Jul. 24, 2007 titled SPORTING DEVICE WITH INTERACTIVE DISPLAY and the disclosure of which is incorporated herein.

### FIELD OF THE INVENTION

The present invention relates to sporting devices, and more specifically to a sporting device having a display system that is interactive with the activity of the sporting event. It is further envisioned that the display system be configured to be responsive to the actions of the sporting activity associated with the sporting device.

### BACKGROUND OF THE INVENTION

Sporting events generally include a number of ancillary display systems that are integrated into the areas generally surrounding the sporting event. Score boards, outfield walls, mezzanine dividers and the like are frequently decorated with any of a number of advertising materials or otherwise populated with sporting information such as player performance statistics, information regarding concurrent sporting activities, etc. In addition to generally surrounding the sporting activity, the display of sporting information has also substantially infiltrated the areas around the field of play. Spectators need not remain in a designated seat to maintain a good degree of awareness as to the status of the game.

The substantial reduction in the cost of tube-type televisions in recent years has allowed for televised views of the game activities to be displayed throughout a stadium or venue. Televisions are readily viewable from virtually any of the concession areas as well as many restroom areas. Additionally, the proliferation of flat panel display systems, such as LCD and plasma screens and monitors, has even further improved the ability of venues to entertain spectators throughout the venue. The improved clarity, larger size, and lighter weight of LCD and plasma screens as compared to tube-based televisions have allowed many venues to incorporate such display systems into areas previously unavailable.

Although the proliferation of digital display systems at sporting events allows the near continuous communication of information to spectators, such systems are not without their drawbacks. Commonly, such displays carry so much non-event advertising information that they detract from the value of even well placed advertising. Generally, many spectators experience information or sensory overload such that very little of the ancillary information, or the non-event related information, can be recalled by a spectator. Even further, as many of the spectators are rightfully preoccupied with the sporting event, many spectators pay such close attention to the event itself that the ancillary information and advertisements displayed on the display systems pass unnoticed.

With general reference to sporting events as a whole, spectators are generally non-receptive to interferences that are placed between themselves and the action of the sporting event. Understandably, some obstructions, such as the end posts associated with a football game, the unbreakable glass associated with hockey or other indoor events such as arena soccer or football, baseball foul posts, and basketball backboards are begrudgingly acceptable as being necessary to the sporting event and/or spectator safety. With particular respect to rink or arena glass and backboard, such sporting accessories are commonly nearly planar and transparent. It is readily appreciated that placing traditional advertisements or other visual imparities on such sporting accessories would detract from the enjoyment or even anger those spectators whose view of the sporting event is obstructed.

Understandably, as many spectators are viewing the sporting event, and the space available for displaying information is limited, the most valuable advertising area would be the spectator's area of interest, i.e. the playing area. Understandably, many venues would be unwilling to allow any team, other than perhaps a home team, or advertiser to advertise on the playing area of a respective venue. Additionally, the permanent nature of such features would most likely render such advertising space as unaffordable but for the wealthiest advertisers.

Therefore, there is a need to provide a sporting accessory that includes a display system capable of displaying information in a manner that does not unduly interfere with the spectator's interaction with the sporting event. Preferably, the display system does not permanently alter the appearance of the sporting accessory and/or the venue. There is a further need to provide sporting accessories that entertain spectators during periods of slow or no play or otherwise display outputs associated with the activity taking place.

### SUMMARY OF THE INVENTION

The present invention is directed to a sporting accessory or device that overcomes one or more of the above-mentioned drawbacks. A sporting accessory display system according to one aspect of the invention is constructed to accentuate the experience of players and spectators without otherwise interfering with game play. That is, the display systems according to the present invention are configured to be uninterruptingly integrated into game play. According to one aspect of the invention, the display is configured to be responsive to game play. According to another aspect of the invention, the display is constructed to be self contained in the sporting accessory such that the display system includes a power system and a control system for generating a desired output. In a preferred aspect of the invention, the display system includes a liquid crystal display or screen that is responsive to electrical stimuli such that the display is selectively operable.

Another aspect of the invention usable with one or more of the above aspects includes forming the sporting device in the shape of a basketball backboard. The basketball backboard includes a faceplate that is constructed to withstand impacts by a basketball. The liquid crystal sheet is disposed proximate the faceplate and configured to generate an output that is visible through the faceplate. The output can be one or more of sporting images and/or advertisements displayed in a manner that does not unduly interfere with game play.

Another aspect of the invention usable with one or more of the above aspects includes a method of manufacturing a sporting device. The sporting device is shaped to facilitate or cooperate with game play. A liquid crystal sheet is incorporated into the sporting device and is controlled so as to temporarily generate an output in response to interaction of the sporting device during the game. Preferably, the sporting device is provided in the shape of a backboard. More preferably, an output is generated in response to player or ball interaction with the backboard. More preferably, the output varies as a function of the severity, area, intensity, or other characteristic of the interaction.

Another aspect of the invention usable with one or more of the aspects above includes providing a battery power source for powering the display thereby limiting extraneous connections with the sporting device.

A further aspect of the invention is to provide a remote interface with the display system. A further aspect includes a database that is configured to communicate with the controller such that the display can generate a variety of different outputs. Preferably, the outputs are associated with the sport of the sporting device and/or advertisements for goods/services associated with the sport being played.

These and various other features, aspects, and advantages of the present invention will be made apparent from the following detailed description and the drawings.

### BRIEF DESCRIPTION OF THE DRAWINGS

The drawings illustrate one preferred embodiment presently contemplated for carrying out the invention.

In the drawings:

FIG. 1 is an elevational view of a sporting device in the shape of a basketball backboard having a display structure according to the present invention;

FIG. 2 is a side view of the backboard shown in FIG. 1;

FIG. 3 is a view similar to FIG. 1 with the display structure activated to generate a graphic output;

FIG. 4 is a graphical representation of the operation of the display structure shown in FIG. 3;

FIG. 5 is a schematic representation of the display structure shown in FIG. 1; and

FIGS. 6-9 show a number of different outputs that can be generated with the display structure shown in FIG. 4.

### DETAILED DESCRIPTION OF THE INVENTION

With reference now to the drawing figures in which like reference numerals designate like parts throughout the disclosure, a sporting device 10, or a device commonly associated with the play of a game, includes a game structure 12 associated with a game to be played with the sporting device 10. As shown, sporting device 10 is generally referred to as a basketball hoop having the game structure of a backboard. Understandably, sporting device 10 could be provided in any of a number of shapes and configurations such as a field goal marker, a foul ball marker, an arena board, etc. The game structure of many such sporting devices can be inherent in the shape of the sporting device. It is envisioned that the present invention is applicable to any of a variety of gaming accessories commonly associated with game or sport activities.

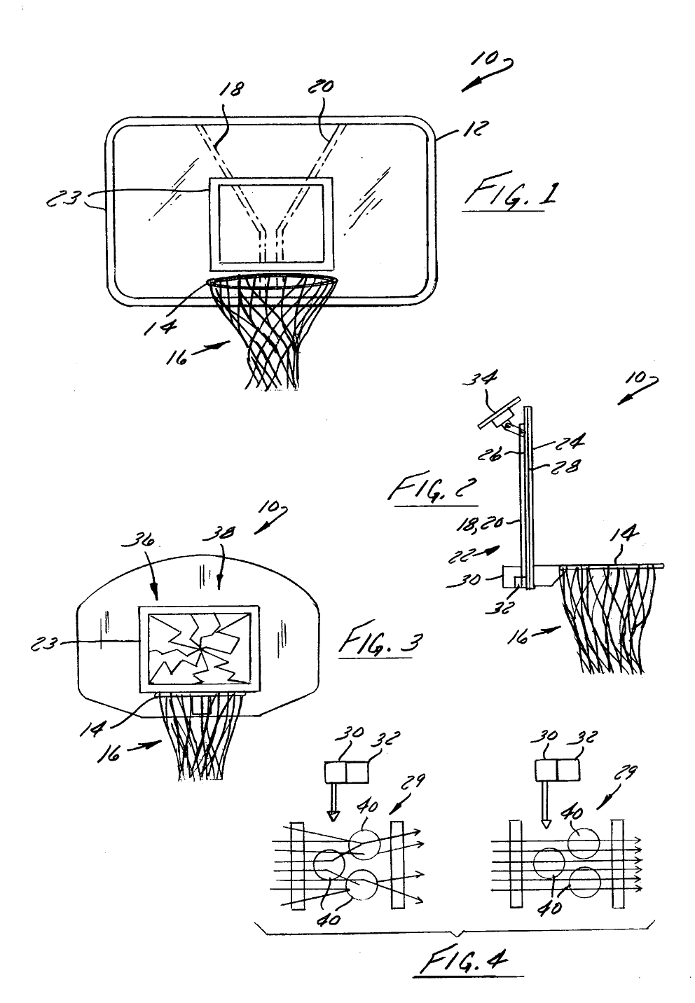

As shown in FIGS. 1-2, backboard 12 is provided with a hoop 14 having a net 16 suspended therefrom. A pair of support rails 18, 20 engage a rear surface 22 of backboard 12 and are constructed to cooperate with a pole or other support structure used to elevate backboard 12. Backboard 12 can be provided with any degree of translucence and is preferably less than opaque and is more preferably transparent. A number of indicia 23 are formed on backboard 12 and provide reference marks with respect to player interaction with backboard 12. As shown in FIG. 1, when sporting device 10 is provides as a backboard 12, an outer indicia indicates an elevation footprint of backboard 12 whereas in interior footprint provides players with an indication of a reference target.

Referring to FIG. 2, backboard 12 includes a front panel 24 and a rear panel 26 which extend upwardly relative to hoop 14. A display structure 28 is disposed between front and rear panels 24, 26 respectively. Display structure 28 is connected to a controller 30 and a power source 32. Although controller 30 and power source 32 are shown as being generally connected to sporting device 10, it is further appreciated that such components could be positioned remotely from the sporting device or otherwise configured to wirelessly communicate with display 28. Power source 32 is envisioned as being a battery power supply, a rechargeable power supply, or a permanent electrical connection to a power grip or the like. Alternatively, or in addition to power source 32, a solar panel 34 may be provided and operationally connected to controller 30 or power source 32 to provide renewable energy for those sporting devices that are located outdoors.

Referring to FIGS. 1-3, display 28 is constructed to provide an output 36 on sporting device 10. Preferably, display 28 is a liquid crystal sheet disposed between panels 24, 26 of backboard 12. Controller and power source 30, 32, 34, respectively, are configured to control the operation of display 28 to selectively generate the desired output 36. As shown in FIG. 3, in one embodiment of the invention, output 36 is configured to provide the illusion that backboard 12 has shattered. Although output 36 is shown as being generally confined by a site target 23, it is appreciated that the entire area of backboard 12 may be utilized to display a desired output 36. It is further appreciated that display 28 may be partitioned and/or otherwise configured such that respective areas of display 28 are independently operable relative to other areas. It is further envisioned that, controller 30 include alternate inputs associated with the structure of sporting device 10 such that output 36 can be generated automatically in response to activity associated with the sporting event or activity. In the embodiment shown, it is envisioned that output 36 be generated automatically in response to the impact of a basketball or player with the structure of backboard 12, hoop 14, or net 16.

Referring to FIG. 4, display 28 includes a liquid crystal sheet 29 that is connected to controller 30 and power source 32 such that when power is communicated to display 28, as shown in the image at right of FIG. 4, a number of molecules 40 associated with liquid crystal sheet 29 are generally aligned or otherwise oriented such that display 28 does not otherwise interfere with the passage of light through the assembly of backboard 12. As shown in the image at the left of FIG. 4, when display 28 is de-energized, molecules 40 interfere with the passage of light through backboard 12. As is commonly understood, the selective application of power to display 28 allows display 28 to be configured to allow a desired output 36 to be displayed through the structure of sporting device 10. Alternatively, display 28 could be configured to be at or near transparent when energized and interfere with the transmission of light when de-energized. It is further appreciated that display 28 could be provided with combinations of such systems such that portions of display 28 interfere with light transmission when energized and other portions do not interfere with light transmission when energized. U.S. Pat. Nos. 5,949,501 and 5,721,694 disclose other variants and further information regarding the construction and operation of liquid crystal sheets.

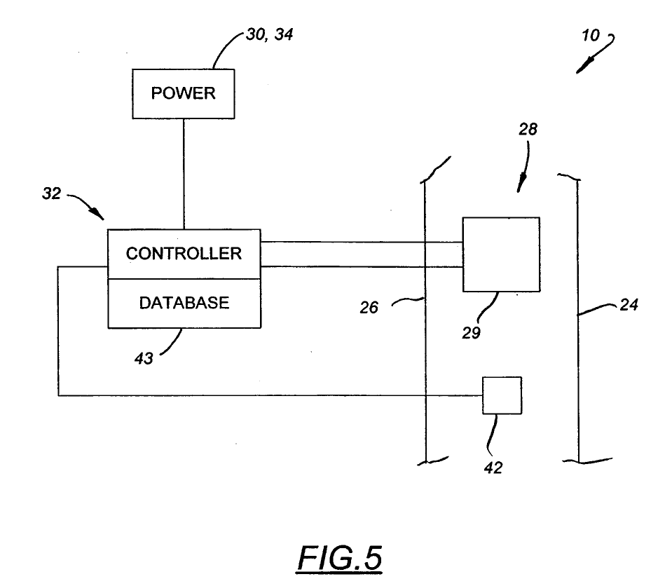

FIG. 5 schematically shows the construction and operation of the display 28. Liquid crystal display 29 is disposed within the structure of sporting device 10. As disclosed above, controller 32 communicates power signals to display 29 to generate the desired alignment or non-transmissive alignment of the respective molecules to generate a desired output 38. Preferably, sporting device 10 includes one or more optional detectors 42. Detector 42 communicates with controller 32 so as to provide an indication of a condition of sporting device 10. For example, detector 42 can be a piezoelectric, stress, strain, accelerometer, position, velocity, or other pressure type sensor that can detect player or ball interaction with panels 24, 26, hoop 14, or net 16 of backboard 12. Although detector 42 is shown as being positioned generally between panels 24, 26, it is appreciated that other types of detectors and other detector positions could be provided. That is, it is envisioned that detector 42 detect changes in one or more of position, velocity, acceleration of a particular sporting device 10 or motion in the vicinity of device 10. Alternatively, detector 42 may be configured to monitor other aspects of sport environments such as sound or the like and generate output 36 in response thereto.

Still another alternative would be to allow users to interact either directly or indirectly with controller 32 to alter or initiate output 36. That is, controller 32 could be configured to communicate with remote controls or the like such that personnel associated with the sporting event can generate a desired output at a desired time. Display 28 includes an optional database 43 that can be configured to deliver a desired signal to the respective areas of the liquid crystal display 29 so as to generate a number of desired graphical images. Preferably, controller 32 and database 43 interact such that, over the duration of a sporting event, a number of unique outputs are generated on display 28. Furthermore, although shown as attached to controller 32, it is appreciated that one or more of controller 32 and database 43 be remote from each other and/or remote or removable from sporting device 10. For example, controller 32 and database 43 may be configured as a flash drive or the like, which can cooperate with one or more devices associated with different sporting events. Such a configuration allows a user to quickly configure the controller for a desired type of output.

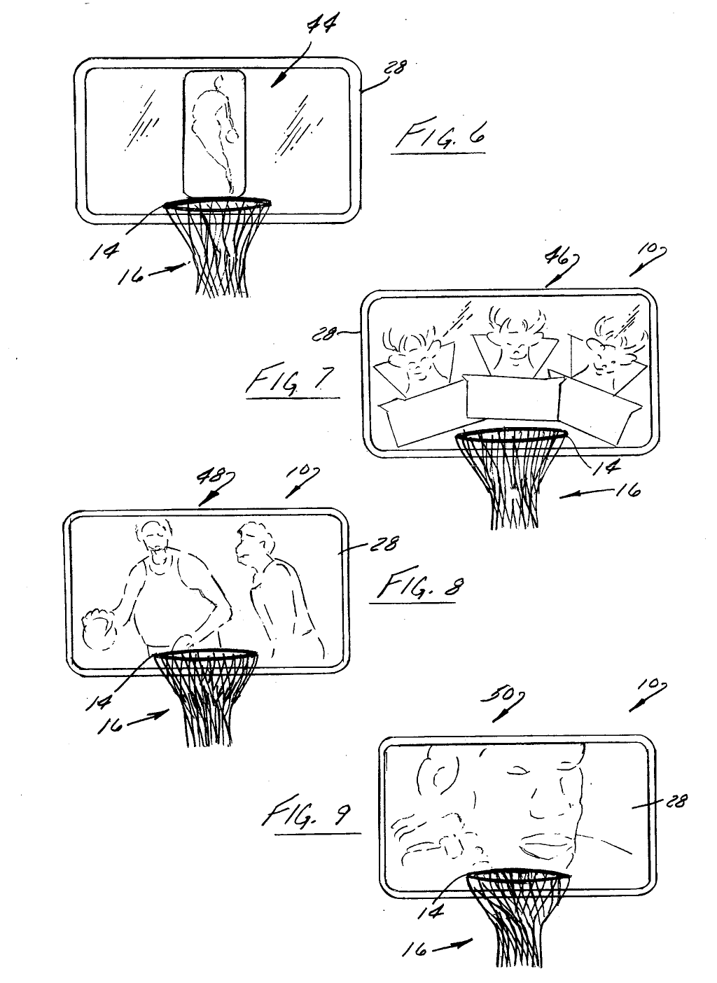

FIGS. 6-9 show a number of exemplary outputs 44, 46, 48, 50 of display 28 of sporting device 10. Understandably, although outputs 44, 46, 48, 50 are generally associated with a basketball event, it is envisioned that the outputs 44, 46, 48, 50 be tailored to any of a variety of activities, advertising, venue, and/or sporting events. That is display 28 can be configured to display any of a variety of information and preferably displays information relevant to the sporting or gaming activity at hand or forthcoming at the venue. The ability to select and control the generation of output 36 allows sporting device 10 to be utilized for advertising and/or spectator entertainment without otherwise interfering with game play. For instance, in a hockey application, if a fight occurs in front of a given set of boards, upon instruction or detection of the fight activities, one or more of the boards around the rink may be configured to display graphics and or signage specific to fights, hockey, first aid, injuries, etc. Likewise, in a baseball or football application, foul ball or field goal posts could be configured to be responsive to the impact of balls with the respect posts. Additionally, such posts could be maintained in a generally transparent state until needed or involved in play. It is further envisioned that the output of such displays be indicative of the results of the sporting activity. For instance, foul posts may indicate the side to which the ball passed thereby indicating whether the ball was fair or foul by generating a directional pulsed output in a given direction or other event specific output.

Regardless of the activity associated sporting device 10, providing a sporting device that is responsive to the sporting activity enhances spectator enjoyment of the sporting event. Furthermore, by selectively generating the output associated with the display, the sporting device does not unduly detract from the spectator's enjoyment of the activity by interfering with the users viewing of the activity throughout the duration of the activity. Furthermore, during breaks in the sporting activity, display 28 can be used for advertising or other graphic displays not otherwise directly related to concurrent game play. Such a configuration allows greater placement of advertising and more direct advertising placement with respect to spectator attention.

Various alternatives are contemplated as being within the scope of the following claims that particular point out and distinctly claim the subject matter regarded as the invention.

What is claimed is:

1. A sporting device comprising:
a game structure associated with a game to be played using the sporting device, the structure being less than opaque; and
a display structure positioned proximate the structure and operable to provide an output through the structure.

2. The sporting device of claim 1 further comprising a power source supported by the game structure and configured to power the display structure.

3. The sporting device of claim 1 wherein the sporting device is one of a backboard, a goal assembly, a net assembly, an arena board, or a position indicator and the display device is a liquid crystal sheet.

4. The sporting device of claim 3 further comprising a controller configured to manipulate operation of the liquid crystal sheet.

5. The sporting device of claim 4 further comprising an input connected to the controller and responsive to events associated with the game structure.

6. The sporting device of claim 5 wherein the controller is configured to instruct the display to output one of an event illusion, a team logo, or a graphical display.

7. The sporting device of claim 6 wherein the controller is configured to sequentially generate one or more of the event illusion, the team logo, and the graphical display.

8. A basketball backboard comprising:
a faceplate constructed to withstand impacts by a basketball; and
a liquid crystal sheet disposed proximate the faceplate and configured to generate an output that is visible through the faceplate.

9. The basketball backboard of claim 8 further comprising a controller configured to control operation of the liquid crystal sheet.

10. The basketball backboard of claim 8 further comprising an input operatively connected to the faceplate and responsive to activity of the backboard for providing operating instructions to the liquid crystal sheet.

11. The basketball backboard of claim 8 wherein the liquid crystal sheet includes a number of sections that are independently operable.

12. The basketball backboard of claim 8 further comprising a power source for powering the liquid crystal sheet.

13. A method of manufacturing a sporting device comprising:
shaping the sporting device to cooperate with a play of a game;
incorporating a liquid crystal sheet into the sporting device; and
controlling the liquid crystal sheet to temporarily generate an output in response to interaction of the sporting device during the game.

14. The method of claim 13 further comprising providing a database of a number of outputs for the liquid crystal sheet.

15. The method of claim 13 wherein shaping the sporting device further comprises forming one of a backboard, a goal assembly, a net assembly, an arena board, or a position indicator.

16. The method of claim 15 wherein the step of controlling the liquid crystal sheet further comprises generating the output in response to an impact between a ball and the sporting device.

17. The method of claim 13 wherein the output is further defined as displaying a translucent graphic within a border of the sporting device.

18. The method of claim 17 wherein the translucent graphic is one of sports related or an advertisement.

19. The method of claim 13 further comprising communicating an electrical signal to portions of the liquid crystal sheet to generate the output.

20. The method of claim 19 further comprising communicating the electrical signal from a battery source supported by the sporting device.
